(19) United States
(12) Patent Application Publication
(10) Pub. No.: US 2026/0040174 A1
(43) Pub. Date: Feb. 5, 2026

(54) IMPROVE HANDOVER PERFORMANCE IN INTER VENDOR HANDOVER SCENARIO

(71) Applicant: DISH Wireless L.L.C., Englewood, CO (US)

(72) Inventor: Karupaiah Rajendran, Sachse, TX (US)

(21) Appl. No.: 18/793,640

(22) Filed: Aug. 2, 2024

(51) Int. Cl. H04W 36/00

(52) U.S. Cl. CPC H04W 36/13; H04W 36/00833

(57) ABSTRACT

Technologies for efficient handover in inter vendor handover scenario in a cellular network are described. One method include sending, by a source base station, a handover request to a target base station; exchanging a plurality of handover parameters with the target node; determining whether a matched set of the plurality of handover parameters exists; responsive to determining that the matched set exists, sending a notification regarding the matched set to the target base station; and performing handover with user equipment (UE) using the matched set of the plurality of handover parameters.

### BACKGROUND

Cellular networks are highly complex. One type of cellular network is a fifth generation (5G) new radio (NR) cellular networks. 5G NR cellular networks have the promise to provide higher throughput, lower latency, and higher availability compared with previous global wireless standards. However, some handover scenario in a 5G NR cellular network cannot be handled efficiently, which may compromise such promise.

### BRIEF DESCRIPTION OF THE DRAWINGS

The present disclosure is illustrated by way of example, and not by way of limitation, in the figures of the accompanying drawings.

FIG. 1 is a block diagram of a system implementing efficient handover in inter vendor handover scenario in a cellular network according to at least one embodiment.

FIG. 2 is a block diagram of a system including a handover manager that implements efficient handover in inter vendor handover scenario in a cellular network according to at least one embodiment.

FIG. 3 is a block diagram of example implementations of efficient handover between various base stations in inter vendor handover scenario in a cellular network according to at least one embodiment.

FIG. 4 illustrates an example signal transmitted from a base station to UE according to at least one embodiment.

FIG. 5 illustrates example handover parameters according to at least one embodiment.

FIGS. 6, and 7 are flow diagrams of example methods of efficient handover in inter vendor handover scenario in a cellular network according to at least one embodiment.

### DETAILED DESCRIPTION

Technologies for efficient handover in inter vendor handover scenario in a telecommunications network, such as a cellular network (e.g., 5G wireless network, 6G wireless network) are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

The handover in inter vendor handover scenario can be hard to implement because of incompatibility or inconsistence of system configurations used by different vendors.

Aspects and embodiments of the present disclosure address the above and other deficiencies by providing a system that implements efficient handover in inter vendor handover scenario in a cellular network. Specifically, a component of the cellular network (e.g., handover manager) may be implemented into each of the base stations in the cellular network. The base station (e.g., “gNodeB” or “gNB”) refers to a network element responsible for the transmission and reception of radio signals in one or more cells (or coverage areas) to or from user equipment (UE). The handover can be made from a source base station and a target base station. The source base station is the base station that UE is connected to before handover, and the target base station is the base station that UE is connected to after handover. In some implementations, the source base station may include software packages that provide configurations for handover based on a first vendor's setting, and the target base station may include software packages that provide configurations for handover based on a second vendor's setting.

The source base station may send a handover request to the target base station. In addition to the handover request, the handover manager of the source base station may start the process of exchanging information regarding parameters associated with handover (“handover parameters”) with handover manager of the target base station. For example, the handover manager of the source base station may send handover parameters that are required in this handover (“source handover parameters”) to the handover manager of the target base station, and the handover manager of the target base station, upon receiving the source handover parameters, may compare the received handover parameters with its corresponding handover parameters (“target handover parameters”). The handover manager of the target base station may flag the unmatched handover parameters between the source handover parameters and the target handover parameters. The handover manager of the target base station may attempt to reconfigure the unmatched handover parameters such that the target handover parameters all match the source handover parameters.

In some cases, the handover manager of the target base station may be able to successfully reconfigure the unmatched handover parameters, and in such cases, the handover manager of the target base station may determine that a matched set of the handover parameters has existed and then send to the handover manager of the source base station an acknowledgement that the handover parameters matching is finished.

In some cases, the handover manager of the target base station may be unable to reconfigure one or more of the unmatched handover parameters, and in such cases, the handover manager of the target base station may send the information regarding these un-reconfigured, unmatched handover parameters to the handover manager of the source base station. The handover manager of the source base station may attempt to reconfigure these handover parameters such that the target handover parameters all match the source handover parameters. In some cases, the handover manager of the source base station may be able to successfully reconfigure these handover parameters, and in such cases, the handover manager of the source base station may determine that a matched set of the handover parameters has existed and then send to the handover manager of the target base station an acknowledgement that the handover parameters matching is finished. In some cases, the handover manager of the source base station may be unable to reconfigure these handover parameters, and in such cases, the handover manager of the source base station and the handover manager of the target base station may continue the exchange of information and performing the handover parameters matching until the target handover parameters all match the source handover parameters. As such, by reconfiguring contain handover parameters, the handover managers may coordinate with each other to complete the handover parameters matching.

Upon the handover parameters matching is finished, the handover manager of the source base station and the handover manager of the target base station may initialize or continue handover with UE using the matched set of handover parameters. Each of the handover manager of the source base station and the handover manager of the target base station may then notify the corresponding component in the respective base station to perform the handover as normal. For example, the target base station may perform the admission control based on slice information to admit UE as a normal procedure after receiving the handover request from the source base station.

In some cases, if exchange of information with attempted handover parameters matching have been performed in a specific number of rounds, between the handover manager of the source base station and the handover manager of the target base station, that exceeds a threshold value (e.g., over X rounds), the handover manager of the source base station and/or the handover manager of the target base station may send an error notification for the handover, where the corresponding base station can notify the corresponding vendor regarding the information of the unmatched handover parameters.

The handover parameters may include parameters associated with the transmission of synchronization signals, measurement gap related parameters, and other essential parameters for performing the handover. The parameters associated with the transmission of synchronization signals may include a location of synchronization signal transmitted in a physical resource block (or half frame location), an index of the physical resource block, etc. The measurement gap related parameters may include measurement gap length, measurement gap periodicity, measurement gap pattern, measurement gap offset, measurement gap identifier, etc.

Aspects and embodiments of the present disclosure can use information exchange between base stations and reconfiguration of handover parameters for efficient handover in inter vendor handover scenario in the cellular network. Aspects and embodiments of the present disclosure can improve handover performance. Fine tuning of parameters associated with synchronization signal transmission and measurement gap related parameters along with traffic profile supported by the cellular system not only helps resolve the existing handover difficulties in inter vendor handover scenario but also enables smooth automatic neighbor relation (ANR) and handover operation.

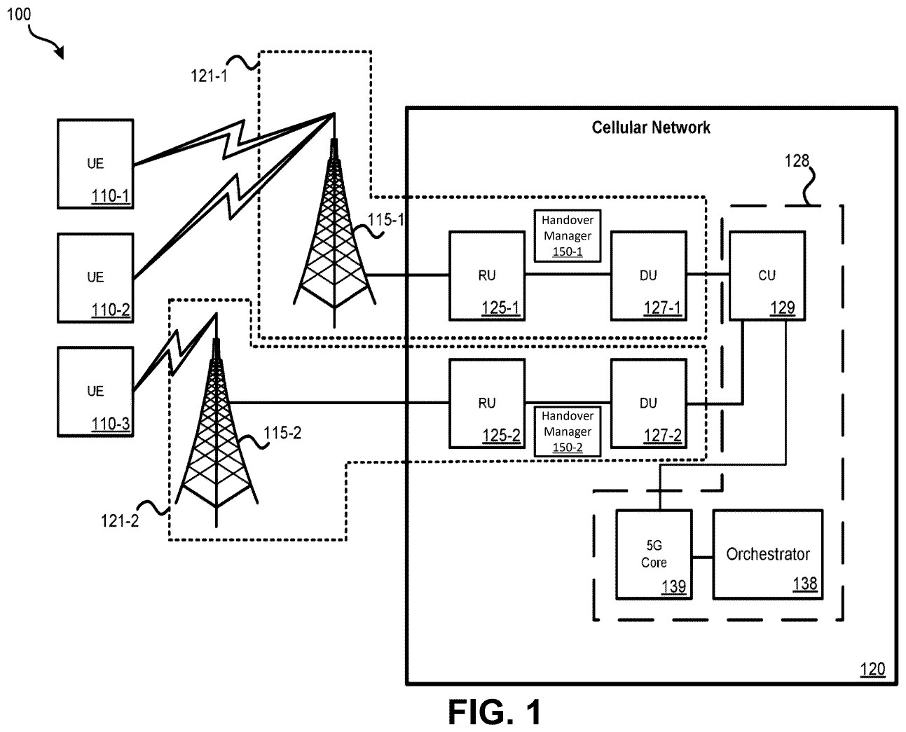

FIG. 1 illustrates an embodiment of a cellular network system 100 (“system 100”). FIG. 1 represents an embodiment of a cellular network which can accommodate the cloud-based architecture. System 100 can include a 5G New Radio (NR) cellular network; other types of cellular networks, such as 6G, 7G, etc. may also be possible. System 100 can include: UEs 110 (UE 110-1, UE 110-2, UE 110-3); base station 121; cellular network 120; radio units 125 (“RUs 125”); distributed units 127 (“DUs 127”); centralized unit 129 (“CU 129”); 5G core 139, and orchestrator 138. FIG. 1 represents a component-level view. In an open radio access network (O-RAN), because components can be implemented as specialized software executed on general-purpose hardware, except for components that need to receive and transmit radio frequency (RF), the functionality of the various components can be shifted among different servers. For at least some components, the hardware may be maintained by a separate cloud-service provider, to accommodate where the functionality of such components is needed.

UE 110 can represent various types of end-user devices, such as cellular phones, smartphones, cellular modems, cellular-enabled computerized devices, sensor devices, gaming devices, access points (APs), any computerized device capable of communicating via a cellular network, etc. Generally, UE can represent any type of device that has an incorporated 5G interface, such as a 5G modem. Examples can include sensor devices, Internet of Things (IoT) devices, manufacturing robots; unmanned aerial (or land-based) vehicles, network-connected vehicles, etc. Depending on the location of individual UEs, UE 110 may use RF to communicate with various base stations of cellular network 120. As illustrated, two base stations 121 are illustrated: base station 121-1 can include: structure 115-1, RU 125-1, and DU 127-1. Structure 115-1 may be any structure to which one or more antennas (not illustrated) of the base station are mounted. Structure 115-1 may be a dedicated cellular tower, a building, a water tower, or any other human-made or natural structure to which one or more antennas can reasonably be mounted to provide cellular coverage to a geographic area. Similarly, base station 121-2 can include: structure 115-2, RU 125-2, and DU 127-2.

Real-world implementations of system 100 can include many (e.g., thousands) of base stations (BSs) and many CUs and 5G core 139. Structures 115 can include one or more antennas that allow RUs 125 to communicate wirelessly with UEs 110. RUs 125 can represent an edge of cellular network 120 where data is transitioned to wireless communication. The radio access technology (RAT) used by RU 125 may be 5G New Radio (NR), or some other RAT. The remainder of cellular network 120 may be based on an exclusive 5G architecture, a hybrid 4G/5G architecture, a 4G architecture, or some other cellular network architecture. Base station 121 equipment may include an RU (e.g., RU 125-1) and a DU (e.g., DU 127-1).

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. One or more DUs, such as DU 127-1, may communicate with CU 129.

Collectively, an RU, DU, and CU create a gNodeB, which serves as the radio access network (RAN) of cellular network 120. CU 129 can communicate with 5G core 139. The specific architecture of cellular network 120 can vary by embodiment. Edge cloud server systems outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

While FIG. 1 illustrates various components of cellular network 120, other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In an O-RAN arrangement, specialized software on general-purpose hardware may be used to perform the functions of components such as DU 127, CU 129, and 5G core 139. Functionality of such components can be co-located or located at disparate physical server systems. For example, certain components of 5G core 139 may be co-located with components of CU 129.

In a possible virtualized O-RAN implementation, CU 129, 5G core 139, and/or orchestrator 138 can be implemented virtually as software being executed by general-purpose computing equipment, such as in a data center of a cloud-computing platform, as detailed herein. Therefore, depending on needs, the functionality of a CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100A, cloud-based cellular network components 128 include CU 129, 5G core 139, and orchestrator 138. Such cloud-based cellular network components 128 may be executed as specialized software executed by underlying general-purpose computer servers. Cloud-based cellular network components 128 may be executed on a third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested.

Kubernetes, or some other container orchestration platform, can be used to create and destroy the logical CU or 5G core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. (Rather, processing and storage capabilities of the data center would be devoted to the needed functions.) When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new core function, orchestrator 138 can perform a pipeline of calling the core function code from a software repository incorporated as part of, or separate from, cellular network 120; pulling corresponding configuration files (e.g., helm charts); creating Kubernetes nodes/pods; loading the related core function containers; configuring the core function; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet defined SLA parameters. By controlling the location and amount of computing and communication resources allocated to a network slice, the quality of service (QoS) and quality of experience (QoE) for UE can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1, a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Components such as DUs 127, CU 129, orchestrator 138, and 5G core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

5G core 139, which can be physically distributed across data centers or located at a central national data center (NDC), can perform various core functions of the cellular network. 5G core 139 can include: network resource management components; policy management components; subscriber management components; and packet control components. Individual components may communicate on a bus, thus allowing various components of 5G core 139 to communicate with each other directly. 5G core 139 is simplified to show some key components. Implementations can involve additional other components.

Network resource management components can include network repository function (NRF) and network slice selection function (NSSF). NRF can allow 5G network functions (NFs) to register and discover each other via a standards-based application programming interface (API). NSSF can be used by access and mobility management function (AMF) to assist with the selection of a network slice that will serve a particular UE.

Policy management components can include charging function (CHF) and policy control function (PCF). CHF allows charging services to be offered to authorized network functions. Converged online and offline charging can be supported. PCF allows for policy control functions and the related 5G signaling interfaces to be supported.

Subscriber management components can include unified data management (UDM) and authentication server function (AUSF). UDM can allow for generation of authentication vectors, user identification handling, NF registration management, and retrieval of UE individual subscription data for slice selection. AUSF performs authentication with UE.

Packet control components can include access and mobility management function (AMF) and session management function (SMF). AMF can receive connection- and session-related information from UE and is responsible for handling connection and mobility management tasks. SMF is responsible for interacting with the decoupled data plane, creating, updating, and removing protocol data unit (PDU) sessions, and managing session context with the user plane function (UPF).

User plane function (UPF) can be responsible for packet routing and forwarding, packet inspection, QoS handling, and external PDU sessions for interconnecting with a data network (DN) (e.g., the Internet) or various access networks. Access networks can include the RAN of cellular network 120.

5G core 139 may reside on a cloud computing platform. While from a client's or user's point of view, the “cloud” can be envisioned as an ephemeral computing workspace that occupies no physical space, in reality, a cloud computing platform is an interconnected group of data centers throughout which computing and storage resources are spread. Therefore, data centers may be scattered geographically and can provide redundancy.

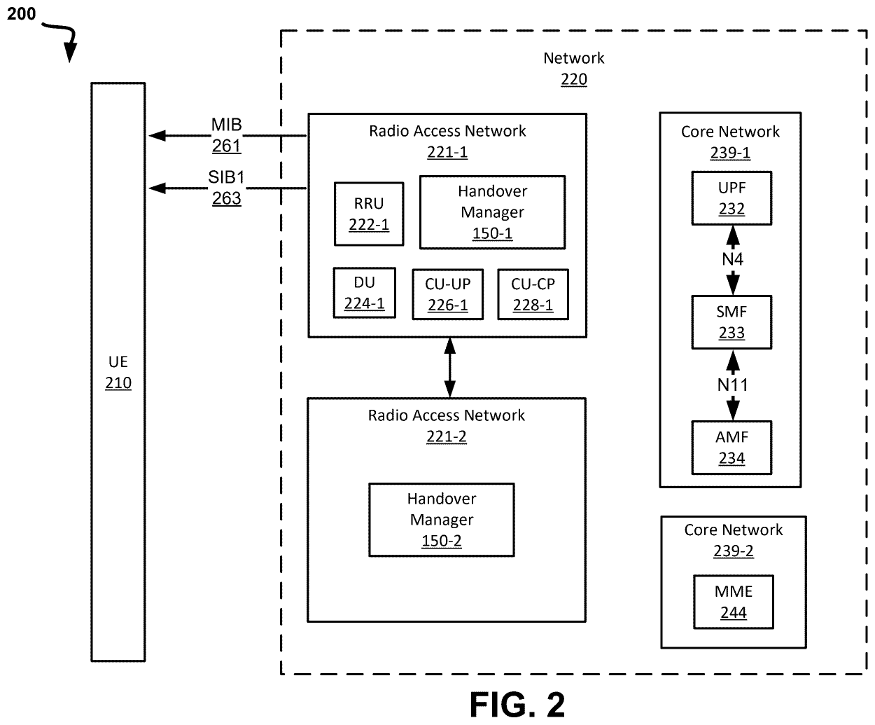

In some embodiments, each base station can include a handover manager 150 to implement efficient handover in a cellular network. For example, the base station 121-1 includes a handover manager 150-1 and the base station 121-2 includes a handover manager 150-2. Further details regarding the operations of the handover manager are described below with reference to FIGS. 2-7.

FIG. 2 is a block diagram of example handover managers according to at least one embodiment. Referring to FIG. 2, a network 220 includes one or more radio access network (RAN) 221-1, 221-2, and one or more core network 239-1, 239-2 according to at least one embodiment. The network 220 may include 4G network, 5G network, 6G network, etc. The network 220 connects user equipment (UE) 210 to the data network (not shown), and the data network can include the Internet, a local area network (LAN), a wide area network (WAN), a private data network, a wireless network, a wired network, or a combination of networks. The UE 210 can include an electronic device with wireless connectivity or cellular communication capability, such as a mobile phone or handheld computing device. In at least one example, the UE 210 can include a 5G smartphone or a 5G cellular device that connects to the RAN 221-1, 221-2 via a wireless connection. The UE 210 can include one of a number of UEs not depicted that are in communication with the RAN 221-1, 221-2. The UE 210 may include mobile and non-mobile computing devices. The UE 210 may include laptop computers, desktop computers, an Internet-of-Things (IoT) devices, and/or any other electronic computing device that includes a wireless communications interface to access the RAN 221-1, 221-2.

The RAN 221-1 includes a remote radio unit (RRU) 222-1 for wirelessly communicating with UE 210. The remote radio unit (RRU) 222-1 can include a Radio Unit (RU) and may include one or more radio transceivers for wirelessly communicating with UE 210. The remote radio unit (RRU) 222-1 may include circuitry for converting signals sent to and from an antenna of a Base Station into digital signals for transmission over packet networks. In some implementations, the RAN 221-1 may correspond with a 5G radio Base Station that connects user equipment to the core network 239-1. The 5G radio Base Station may be referred to as a generation Node B, a “gNodeB,” or a “gNB.” In some implementations, the RAN 221-1 may correspond with a fourth generation (4G) or long term evolution (LTE) radio Base Station that connects user equipment to the core network 239-2. The 4G radio Base Station may be referred to as an evolved Node B, a “eNodeB,” or a “eNB.” A Base Station may refer to a network element that is responsible for the transmission and reception of radio signals in one or more cells to or from user equipment, such as UE 210.

The RAN 221-1 can include a new-generation radio access network (NG-RAN) that uses the 5G NR interface. In some embodiments, the distributed unit (DU) 224-1 and the centralized unit (CU) of the RAN 221-1 may be co-located with the RRU 222-1. In other embodiments, the DU 224-1 and the RRU 222-1 may be co-located at a cell site and the centralized unit (CU) may be located within a local data center (LDC). The DU 224-1 can include a logical node configured to provide functions for the radio link control (RLC) layer, the medium access control (MAC) layer, and the physical layer (PHY) layers. The centralized unit (CU) can be partitioned into a CU user plane portion (CU-UP) 226-1 and a CU control plane portion (CU-CP) 228-1. The CU-CP 228-1 may perform functions related to a control plane, such as connection setup, mobility, and security. The CU-UP 226-1 may perform functions related to a user plane, such as user data transmission and reception functions. In one example, the centralized units (CUs) can include a logical node configured to provide functions for the radio resource control (RRC) layer, the packet data convergence control (PDCP) layer, and the service data adaptation protocol (SDAP) layer. The centralized unit for the control plane (CU-CP) 228-1 can include a logical node configured to provide functions of the control plane part of the RRC and PDCP. The centralized unit for the user plane (CU-UP) 226-1 can include a logical node configured to provide functions of the user plane part of the SDAP and PDCP. In some embodiments, the RAN 221-1 may include virtualized CU units and virtualized DU units. The virtualized DU units can include virtualized versions of distributed units (DUs). The virtualized CU units can include virtualized versions of centralized units (CUs). Virtualizing the control plane and user plane functions allows the centralized units (CUs) to be consolidated in one or more data centers on RAN-based open interfaces.

In some embodiments, the RAN 221-1 may include a set of one or more remote radio units (RRUs) that includes radio transceivers (or combinations of radio transmitters and receivers) for wirelessly communicating with UEs. The set of RRUs may correspond with a network of cells (or coverage areas) that provide continuous or nearly continuous overlapping service to UEs, such as UE 210, over a geographic area. Some cells may correspond with stationary coverage areas and other cells may correspond with coverage areas that change over time (e.g., due to movement of a mobile RRU).

In some cases, the UE 210 may be capable of transmitting signals to and receiving signals from one or more RRUs within the network of cells over time. One or more cells may correspond with a cell site. The cells within the network of cells may be configured to facilitate communication between UE 210 and other UEs and/or between UE 210 and a data network. The cells may include macrocells (e.g., capable of reaching 18 miles) and small cells, such as microcells (e.g., capable of reaching 1.2 miles), picocells (e.g., capable of reaching 0.12 miles), and femtocells (e.g., capable of reaching 32 feet). Small cells may communicate through macrocells. Although the range of small cells may be limited, small cells may enable mm Wave frequencies with high-speed connectivity to UEs within a short distance of the small cells. Macrocells may transit and receive radio signals using multiple-input multiple-output (MIMO) antennas that may be connected to a cell tower, an antenna mast, or a raised structure.

The core network 239-1 may utilize a cloud-native service-based architecture (SBA) in which different core network functions (e.g., authentication, security, session management, and core access and mobility functions) are virtualized and implemented as loosely coupled independent services that communicate with each other, for example, using hypertext transfer protocol (HTTP) protocols and APIs. In some cases, control plane (CP) functions may interact with each other using the service-based architecture. In at least one embodiment, a microservices-based architecture in which software is composed of small independent services that communicate over well-defined APIs may be used for implementing some of the core network functions. For example, control plane (CP) network functions for performing session management may be implemented as containerized applications or microservices. Although a microservice-based architecture does not necessarily require a container-based implementation, a container-based implementation may offer improved scalability and availability over other approaches. Network functions that have been implemented using microservices may store their state information using the unstructured data storage function (UDSF) that supports data storage for stateless network functions across the service-based architecture (SBA).

The core network 239-1 may include a set of network elements that are configured to offer various data and telecommunications services to subscribers or end users of user equipment, such as UE 210. Examples of network elements include network computers, network processors, networking hardware, networking equipment, routers, switches, hubs, bridges, radio network controllers, gateways, servers, virtualized network functions, and network functions virtualization infrastructure. A network element can include a real or virtualized component that provides wired or wireless communication network services.

The primary core network functions can include the access and mobility management function (AMF) 234, the session management function (SMF) 233, and the user plane function (UPF) 232. The AMF 334 may interface with UE 210, act as a single-entry point for a UE connection, and perform mobility management, registration management, and connection management between data network and UE 210. The AMF 334 may interface with the SMF 333 to track user sessions. The AMF 334 may interface with a network slice selection function (NSSF) 338 to select network slice instances for user equipment. When user equipment is leaving a first coverage area and entering a second coverage area, the AMF 334 may be responsible for coordinating the handoff between the coverage areas whether the coverage areas are associated with the same radio access network or different radio access networks. The SMF 333 may perform session management, user plane selection, and Internet Protocol (IP) address allocation. After the Access Gateway Function (AGF) authenticates the subscriber and establishes a protocol data unit (PDU) session, the SMF 333 may select the UPF for the subscriber.

The UPF 232 may provide subscriber tunnel encapsulations enabled by the general packet radio service (GPRS) tunneling protocol, packet processing including routing and forwarding, quality of service (QoS) handling, packet data unit (PDU) session management, policy enforcement, statistics gathering and reporting, lawful intercept requests processing, and optional advanced services. The UPF 232 may serve as an ingress and egress point for user plane traffic and provide anchored mobility support for user equipment. The UPF 232 may be implemented as a software process or application running within a virtualized infrastructure or a cloud-based compute and storage infrastructure.

The UPF 232 may transfer downlink data received from the data network to the UE 210, via the RAN 221-1 and/or transfer uplink data received from the UE 210 to the data network via the RAN 221-1. An uplink can include a radio link though which UE 210 transmits data and/or control signals to the RAN 221-1. A downlink can include a radio link through which the RAN 221-1 transmits data and/or control signals to the UE 210.

Uplink packets arriving from the RAN 221-1 may use a general packet radio service (GPRS) tunneling protocol (or GTP) to reach the UPF 232. The GPRS tunneling protocol for the user plane may support multiplexing of traffic from different PDU sessions by tunneling user data over the interface N3 between the RAN 221-1 and the UPF 232. The UPF 232 may remove the packet headers belonging to the GTP tunnel before forwarding the user plane packets towards the data network. As the UPF 232 may provide connectivity towards other data networks in addition to the data network, the UPF 232 ensures that the user plane packets are forwarded towards the correct data network. Each GTP tunnel may belong to a specific PDU session. Each PDU session may be set up towards a specific data network name (DNN) that uniquely identifies the data network to which the user plane packets should be forwarded. The UPF 232 may keep a record of the mapping between the GTP tunnel, the PDU session, and the DNN for the data network to which the user plane packets are directed.

Downlink packets arriving from the data network are mapped onto a specific quality of service (QoS) flow belonging to a specific PDU session before forwarded towards the appropriate RAN 221-1. A QoS flow may correspond with a stream of data packets that have equal QoS. The PDU session may utilize one or more QoS flows to exchange traffic (e.g., data and voice traffic) between the UE 210 and the data network. The one or more QoS flows can include the finest granularity of QoS differentiation within the PDU session. The PDU session may belong to a network slice instance through the network 220. To establish user plane connectivity from the UE 210 to the data network, the AMF 234 that supports the network slice instance may be selected and a PDU session via the network slice instance may be established. In some cases, the PDU session may be of type IPv4 or IPv6 for transporting IP packets. The RAN 221-1 may be configured to establish and release parts of the PDU session that cross the radio interface.

Other core network functions may include a network repository function (NRF) for maintaining a list of available network functions and providing network function service registration and discovery, a policy control function (PCF) for enforcing policy rules for control plane functions, an authentication server function (AUSF) for authenticating user equipment and handling authentication related functionality, a network slice selection function (NSSF) for selecting network slice instances, and an application function (AF) (not shown) for providing application services. Application-level session information may be exchanged between the AF and PCF (e.g., bandwidth requirements for QoS). In some cases, when the UE 210 requests access to resources, such as establishing a PDU session or a QoS flow, the PCF may dynamically decide if the UE 210 should grant the requested access based on a location of the UE 210.

The network 220 may provide one or more network slices, where each network slice may include a set of network functions that are selected to provide specific telecommunications services. For example, each network slice can include a configuration of network functions, network applications, and underlying cloud-based compute and storage infrastructure. In some cases, a network slice may correspond with a logical instantiation of a network, such as an instantiation of the network 220. In some cases, the network 220 may support customized policy configuration and enforcement between network slices per service level agreements (SLAs) within the radio access network (RAN) 221-1. User equipment, such as UE 210, may connect to multiple network slices at the same time (e.g., eight different network slices). In some cases, the network 220 may dynamically generate network slices to provide telecommunications services for various use cases, such the enhanced Mobile Broadband (eMBB), Ultra-Reliable and Low-Latency Communication (URLCC), and massive Machine Type Communication (mMTC) use cases.

A cloud-based compute and storage infrastructure can include a networked computing environment that provides a cloud computing environment. Cloud computing may refer to Internet-based computing, where shared resources, software, and/or information may be provided to one or more computing devices on-demand via the Internet (or other network). The term “cloud” may be used as a metaphor for the Internet, based on the cloud drawings used in computer networking diagrams to depict the Internet as an abstraction of the underlying infrastructure it represents.

Virtualization allows virtual hardware to be created and decoupled from the underlying physical hardware. One example of a virtualized component is a virtual router (or a vRouter). Another example of a virtualized component is a virtual machine. A virtual machine can include a software implementation of a physical machine. The virtual machine may include one or more virtual hardware devices, such as a virtual processor, a virtual memory, a virtual disk, or a virtual network interface card. The virtual machine may load and execute an operating system and applications from the virtual memory. The operating system and applications used by the virtual machine may be stored using the virtual disk. The virtual machine may be stored as a set of files including a virtual disk file for storing the contents of a virtual disk and a virtual machine configuration file for storing configuration settings for the virtual machine. The configuration settings may include the number of virtual processors (e.g., four virtual CPUs), the size of a virtual memory, and the size of a virtual disk (e.g., a 64 GB virtual disk) for the virtual machine. Another example of a virtualized component is a software container or an application container that encapsulates an application's environment. In some embodiments, applications and services may be run using virtual machines instead of containers in order to improve security. A common virtual machine may also be used to run applications and/or containers for a number of closely related network services.

The network 220 may implement various network functions, such as the core network functions and radio access network functions, using a cloud-based compute and storage infrastructure. A network function may be implemented as a software instance running on hardware or as a virtualized network function. Virtual network functions (VNFs) can include implementations of network functions as software processes or applications. In at least one example, a virtual network function (VNF) may be implemented as a software process or application that is run using virtual machines (VMs) or application containers within the cloud-based compute and storage infrastructure. Application containers (or containers) allow applications to be bundled with their own libraries and configuration files, and then executed in isolation on a single operating system (OS) kernel. Application containerization may refer to an OS-level virtualization method that allows isolated applications to be run on a single host and access the same OS kernel. Containers may run on bare-metal systems, cloud instances, and virtual machines. Network functions virtualization may be used to virtualize network functions, for example, via virtual machines, containers, and/or virtual hardware that runs processor readable code or executable instructions stored in one or more computer-readable storage mediums (e.g., one or more data storage devices).

RAN 221-2 may be similar to RAN 221-1 as described above. The core network 239-2 may correspond to 4G or LTE network and include mobility management entity (MME) 244. MME may manage idle mode UE tracking process, manage paging process, manage bearer activation/deactivation process, choose the serving gateway (SGW) for a UE at the initial attach, manage core network node relocation at time of intra-LTE handover, manage authentication of UE (by interacting with the home subscriber server (HSS)), manage destination of non-access stratum (NAS) message, manage generation and allocation of temporary identities to UEs, manage authorization of the UE to camp on the service provider's public land mobile network (PLMN), enforces UE roaming restrictions, manage termination point for ciphering/integrity for NAS signaling, manage security key, manage lawful interception of signaling, etc.

When UE 210 moves from one cell to another cell, handover allows UE 210 to stay connected to the network. As UE makes regular measurements of neighboring cells, UE 210 reports the measurements to the network such that the network 220 can initiate and complete the handover. The handover can be made from a source base station and a target base station. The base station (such as “gNB” or “eNB”) is a network element responsible for the transmission and reception of radio signals in one or more cells (or coverage areas) to or from UE 210. The source base station is the base station that UE is connected to before handover, and the target base station is the base station that UE is connected to after handover. In some implementations, the source base station may include software packages that provide configurations for handover based on a first vendor's setting, and the target base station may include software packages that provide configurations for handover based on a second vendor's setting. In most cases, the configurations for handover based on a first vendor's setting and the configurations for handover based on a second vendor's setting are different in part.

The source base station may initialize a handover based on the measurements provided by UE 210. The source base station may obtain the IP address of a target base station. Using FIG. 2 as an illustrative example, RAN 221-1 may be a source base station and RAN 221-2 may be a target base station. In some implementations, RAN 221-1 is configured with one (e.g., first) vender's software package for services, and RAN 221-2 is configured with another (e.g., second) vender's software package for services.

The source base station may send a handover request to the target base station. In addition to the handover request, the handover manager of the source base station may start the process of exchanging information regarding parameters associated with handover (“handover parameters”) with handover manager of the target base station. Specifically, the handover manager 150-1 may exchange parameters associated with handover (“handover parameters”) with handover manager 150-2. In some implementations, the handover manager 150-1 may know the IP address of RAN 221-2 and send, according to the IP address, to the handover manager 150-2, a handover request. In some implementations, the handover request may include or be sent along with handover parameters, of the source base station, that are required in this handover (“source handover parameters”).

For example, the handover manager 150-1 may send source handover parameters to the handover manager 150-2, and the handover manager 150-2, upon receiving the source handover parameters, may compare the received handover parameters with its corresponding handover parameters (“target handover parameters”). The handover manager 150-2 may flag the unmatched handover parameters between the source handover parameters and the target handover parameters. The handover manager 150-2 may attempt to reconfigure the unmatched handover parameters such that the target handover parameters all match the source handover parameters.

In some cases, the handover manager 150-2 may be able to successfully reconfigure the unmatched handover parameters, and in such cases, the handover manager 150-2 may determine that a matched set of the handover parameters has existed and then send to the handover manager 150-1 an acknowledgement that the handover parameters matching is finished.

In some cases, the handover manager 150-2 may be unable to reconfigure one or more of the unmatched handover parameters, and in such cases, the handover manager 150-2 may send the information regarding these un-reconfigured, unmatched handover parameters to the handover manager 150-1. The handover manager 150-1 may attempt to reconfigure these handover parameters such that the target handover parameters all match the source handover parameters. In some cases, the handover manager 150-1 may be able to successfully reconfigure these handover parameters, and in such cases, the handover manager 150-1 may determine that a matched set of the handover parameters has existed and then send to the handover manager 150-2 an acknowledgement that the handover parameters matching is finished. In some cases, the handover manager 150-1 may be unable to reconfigure these handover parameters, and in such cases, the handover manager 150-1 and the handover manager 150-2 may continue the exchange of information and performing the handover parameters matching until the target handover parameters all match the source handover parameters.

In the examples described above, the handover manager 150-1 starts the process of exchanging parameters with the handover manager 150-2, but in some examples, the handover manager 150-2 may start the process of exchanging parameters associated with handover (“handover parameters”) with handover manager 150-1, and the rest of information exchanging are similar to the examples described above as long as the handover parameters matching is completed.

Each of the handover manager 150-1 and the handover manager 150-2 may then notify the corresponding component in the respective base station to perform the handover as normal. For example, the target base station may perform the admission control based on slice information to admit UE as a normal procedure after receiving the handover request from the source base station.

In some cases, if exchange of information with attempted handover parameters matching have been performed in a specific number of rounds, between the handover manager 150-1 and the handover manager 150-2, that exceeds a threshold value (e.g., over X rounds), the handover manager 150-1 and/or the handover manager 150-2 may send an error notification for the handover, where the corresponding base station can notify the corresponding vendor regarding the information of the unmatched handover parameters.

The handover parameters may include parameters associated with the transmission of synchronization signals, measurement gap related parameters, and other essential parameters for performing the handover.

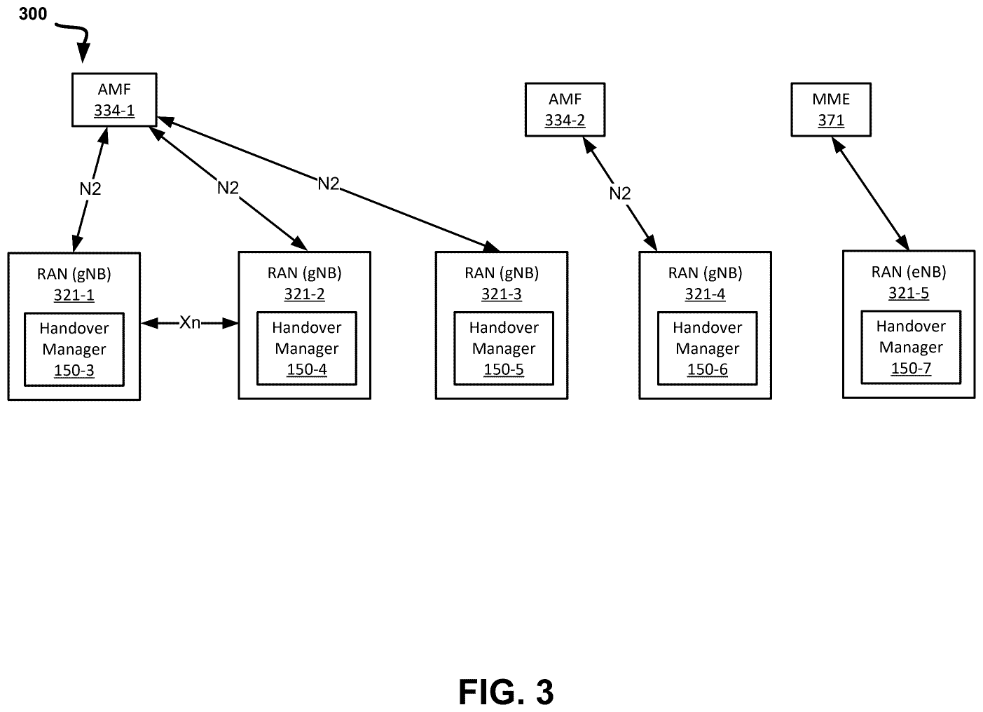

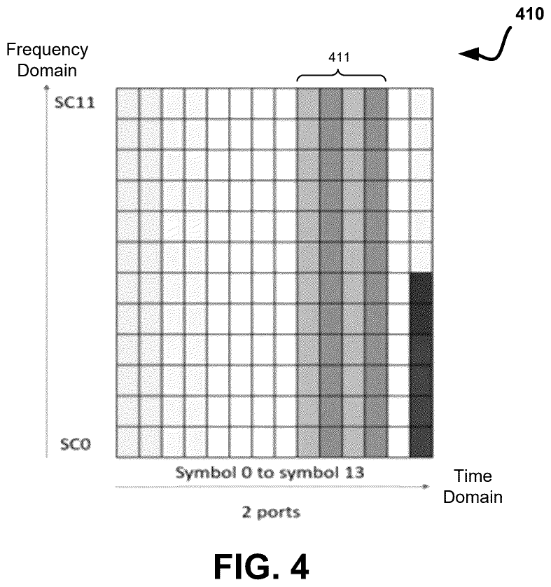

The parameters associated with the transmission of synchronization signals may include a location of synchronization signal transmitted in a physical resource block (or half frame location), an index of the physical resource block, etc. FIG. 4 illustrates an example physical resource block (PRB) 410 transmitted from a base station to a UE. The signal transmitted may include multiple PRBs. The PRB 410 spans 12 subcarriers (SC0-SC11) corresponding to a frequency domain (e.g., 360 kHz), and the smallest time-frequency resource that can be scheduled to the UE is one PRB pair mapped over 14 symbols (Symbol 0-Symbol 13) corresponding to a time domain (e.g., 1 ms for a subframe comprising several symbols). The small block in the PRB 410 can be referred to as resource element, and each resource element corresponds to one subcarrier over one symbol. The PRB 410 includes 168 resource elements. As shown in FIG. 3, 48 resource elements are used to carry the synchronization signal block (SSB) 411. SSB refers to synchronization signal/physical broadcast channel (PBCH) information because synchronization signal and PBCH information are packed as a single block that transmits together. The synchronization signal may include primary synchronization signal (PSS) and secondary synchronization signal (SSS). The PBCH information may include master information block (MIB). MIB may include the parameters that are required to decode system information type 1 (SIB1). The SSB may be transmitted with the periodicity of 20 ms (optionally 5 ms, 10 ms, 20 ms, 40 ms, 80 ms, or 160 ms). Specifically, to enable the communication, both UE and base station in the communication needs to reach agreement on the common configuration, such as by using radio resource control (RRC) messages including SIB1. To setup the initial connection between base station and UE, the base station may create a predefined synchronization signal and put the signal into a specific symbol in a specific subframe and broadcast to UE. The synchronization signal can be referred to as downlink synchronization signal and includes MIB 261 and SIB1 263. UE can decode MIB and use the decoded MIB to decode SIB1.

The location of synchronization signal transmitted in PRB (e.g., PRB 410) may refer to a specific frequency domain and a specific time domain of the synchronization signal (e.g., SC0-SC11 and Symbol 9-Symbol 11 of SSB 411). The half frame location may refer to the first sub-frame (e.g., Symbol 0-Symbol 6 of SSB 411) or the second sub-frame (e.g., Symbol 7-Symbol 13 of SSB 411). The index of the physical resource block may include PRB 1, PRB 2, . . . , PRB n (e.g., PRB 410 may be PRB 2.)

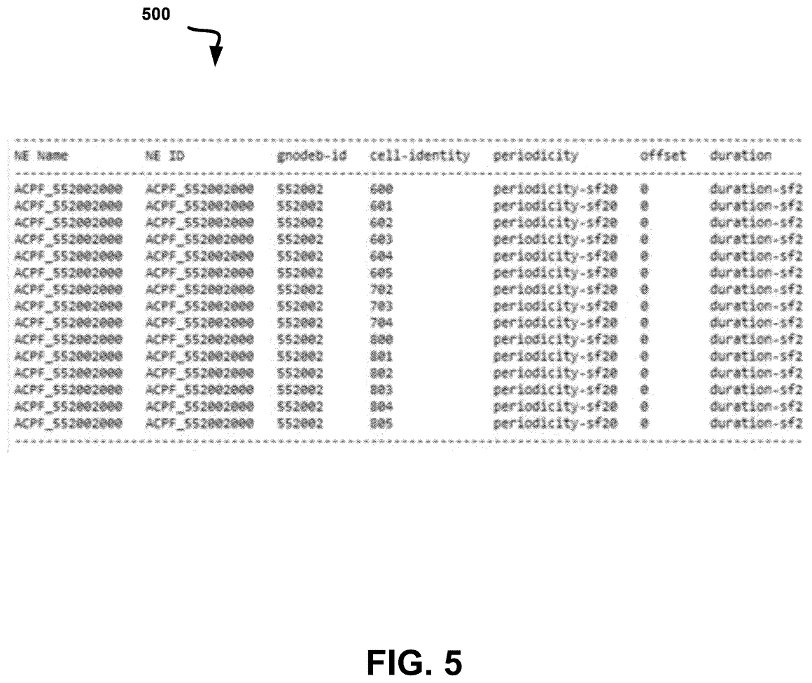

The measurement gap related parameters may include measurement gap length, measurement gap periodicity, measurement gap pattern, measurement gap offset, measurement gap identifier, etc. The measurement gap length refers to duration of time periods that UE can utilize to perform the specific measurement. The measurement gap periodicity refers to the time interval or frequency at which UE can perform the specific measurement. The measurement gap pattern refers to the performance pattern in which UE can perform the specific measurement. The measurement gap offset refers to the offset of the gap pattern. The measurement gap identifier refers an identifier of the measurement gap. FIG. 5 illustrates some examples of measurement gap related parameters.

For every measurement process, the physical entities to be measured include various reference signals. In 4G or LTE, the reference signal for the measurement are synchronization signal and/or cell specific reference signal (CRS). In 5G NR, the reference signal for the measurement are SSB and channel status information reference signal (CSI-RS).

As described above, each of the handover manager 150-1 and the handover manager 150-2 may determine whether a matched set of the plurality of handover parameters exists, and responsive to determining that the matched set exists, send the acknowledge regarding the matched set to each other. Upon the handover parameters matching is finished, the handover manager 150-1 and the handover manager 150-2 may initialize or continue handover with UE using the matched set of the plurality of handover parameters.

FIG. 3 illustrates the handover between various base stations. In some implementations, the handover is from one cell (e.g., a first sector—sector alpha) to another cell (e.g., a second sector—sector beta) while anchored at the same CU in gNB 321-1, the handover manager 150-3 may serve as both source side and target side for efficient handover in inter vendor handover scenario.

In some implementations, the handover is from gNB 321-1 to gNB 321-2, where gNB 321-1 and gNB 321-2 are connected via Xn interface, and in such cases, handover manager 150-3 may be the handover manager of a source base station, and handover manager 150-4 may be the handover manager of a target base station.

In some implementations, the handover is from gNB 321-2 to gNB 321-3, where gNB 321-2 and gNB 321-3 are not connected via Xn interface, each of gNB 321-2 and gNB 321-3 is connected to AMF 334-1 via N2 interface, and in such cases, handover manager 150-4 may be the handover manager of a source base station, and handover manager 150-5 may be the handover manager of a target base station.

In some implementations, the handover is from gNB 321-3 to gNB 321-4, where gNB 321-3 is connected to AMF 334-1 via X2 interface and gNB 321-4 is connected to AMF 334-2 via N2 interface, AMF 334-1 and AMF 334-2 may be connected via N14 interface, and in such cases, handover manager 150-5 may be the handover manager of a source base station, and handover manager 150-6 may be the handover manager of a target base station.

In some implementations, the handover is from gNB 321-4 to eNB 321-5, where gNB 321-4 is connected to AMF 334-2 via X2 interface and eNB 321-5 is connected to MME 371, AMF 334-2 and MME 371 may be connected via N26 interface, and in such cases, handover manager 150-6 may be the handover manager of a source base station, and handover manager 150-7 may be the handover manager of a target base station.

In some implementations, a system (e.g., system 100 in FIG. 1, or system 200 in FIG. 2) may include a computing system to facilitate a cellular network (e.g., the cellular network 120 in FIG. 1, or 5G network in FIG. 2), the computing system may include one or more processing devices and memory communicatively coupled with and readable by the one or more processing devices and having stored therein processor-readable instructions which, when executed by the one or more processing devices, cause the one or more processing devices to perform operations described herein.

The computing system may be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The processing device may represent one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like. Processing device may be configured to execute processor-readable instructions for performing the operations and steps discussed herein.

The memory may represent any combination of the different types of non-volatile memory devices (e.g., not- and (NAND) type flash memory and write-in-place memory, such as a three-dimensional cross-point (“3D cross-point”) memory device) and/or volatile memory devices (e.g., random access memory (RAM), such as dynamic random access memory (DRAM) and synchronous dynamic random access memory (SDRAM)). Examples of memory include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory further include a dual in-line memory module (DIMM), a small outline DIMM (SO-DIMM), and various types of non-volatile dual in-line memory modules (NVDIMMs).

In some implementations, a system (e.g., system 100 in FIG. 1, or system 200 in FIG. 2) may include one or more non-transitory, computer-readable storage media having computer-readable instructions thereon which, when executed by one or more processing devices, cause the one or more processing devices to perform operations described herein. The term “computer-readable storage medium” should be taken to include a single medium or multiple media that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media. Processor-readable instructions or computer-readable instructions may include instructions to implement functionality corresponding to a handover manager (e.g., the handover manager of FIGS. 1-3).

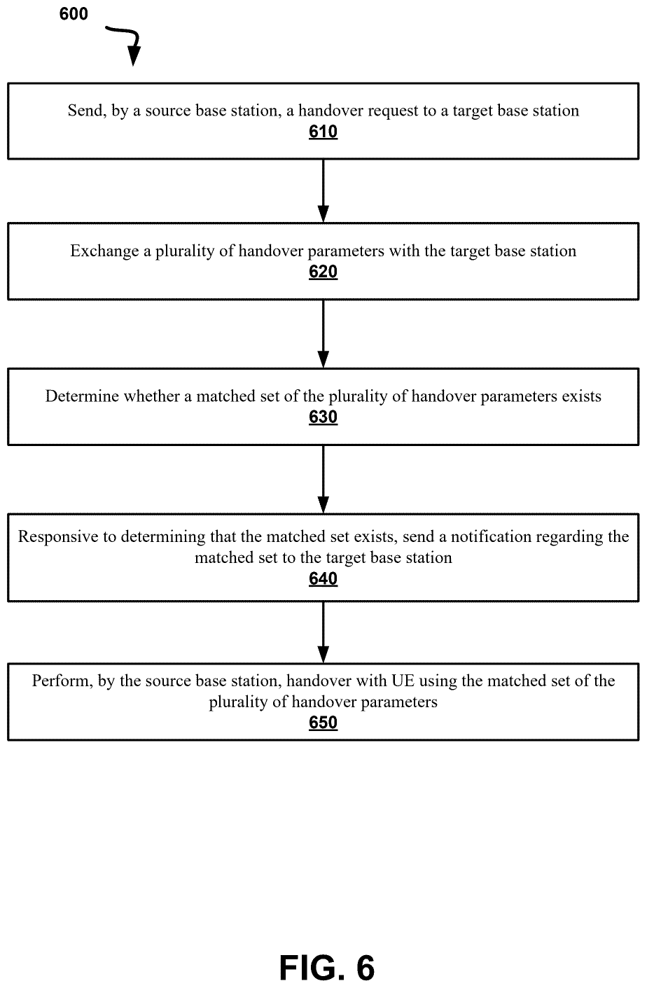

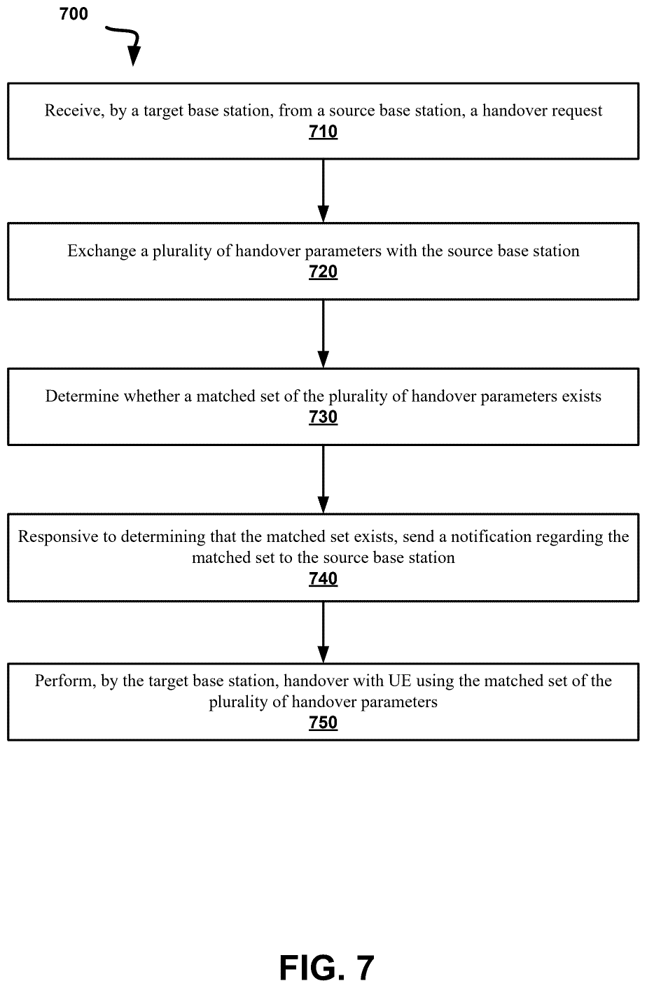

FIGS. 6 and 7 are flow diagrams of methods 600 and 700 of efficient handover in inter vendor handover scenario in a cellular network according to at least one embodiment. The of methods 600 and 700 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the methods 600 and 700 are performed by the system 100 of FIG. 1. In one embodiment, the methods 600 and 700 are performed by the handover manager of FIGS. 1-3. In one embodiment, the method 600 is performed by the handover manager of a source base station (e.g., handover manager 150-1), and the method 700 is performed by the handover manager of a target base station (e.g., handover manager 150-2).

Referring to FIG. 6, at operation 610, the processing device may send, by a source base station, a handover request to a target base station.

At operation 620, the processing device may exchange a plurality of handover parameters with the target base station. In some implementations, the plurality of handover parameters comprises at least one of: a parameter associated with transmission of synchronization signals, a measurement gap related parameter, and an essential parameter for performing the handover. In some implementations, the parameter associated with transmission of synchronization signals comprises at least one of: a location of synchronization signal transmitted in a physical resource block, or an index of the physical resource block. In some implementations, the measurement gap related parameter comprises at least one of: a measurement gap length, a measurement gap periodicity, a measurement gap pattern, a measurement gap offset, or a measurement gap identifier.

In some implementations, the processing device may send, to the target base station, information of a set of source handover parameters of the plurality of handover parameters, and receive, from the target base station, a notification that the set of source handover parameters has been matched with a set of target handover parameters of the plurality of handover parameters.

In some implementations, the processing device may send, to the target base station, information of a set of source handover parameters of the plurality of handover parameters, receive, from the target base station, a notification that a subset of the set of source handover parameters has not been matched with a set of target handover parameters of the plurality of handover parameters, and reconfigure the subset of the set of source handover parameters to match with the set of target handover parameters.

At operation 630, the processing device may determine whether a matched set of the plurality of handover parameters exists. In some implementations, to determine whether a matched set of the plurality of handover parameters exists, the processing device may determine whether a set of source handover parameters of the plurality of handover parameters matches with a set of target handover parameters of the plurality of handover parameters.

At operation 640, responsive to determining that the matched set exists, the processing device may send a notification regarding the matched set to the target base station. In some implementations, the processing device may receive, from the target base station, an acknowledgement to confirm the receipt of the notification regarding the matched set. In some implementations, responsive to determining that the matched set does not exist, the processing device may send, to a service provider, a request to have one or more handover parameters of the plurality of handover parameters be matched with corresponding handover parameters of the target base station.

At operation 650, the processing device may perform handover with user equipment (UE) using the matched set of the plurality of handover parameters.

Referring to FIG. 7, at operation 710, the processing device may receive, by a target base station, from a source base station, a handover request.

At operation 720, the processing device may exchange a plurality of handover parameters with the source base station. In some implementations, the plurality of handover parameters comprises at least one of: a parameter associated with transmission of synchronization signals, a measurement gap related parameter, and an essential parameter for performing the handover. In some implementations, the parameter associated with transmission of synchronization signals comprises at least one of: a location of synchronization signal transmitted in a physical resource block, or an index of the physical resource block. In some implementations, the measurement gap related parameter comprises at least one of: a measurement gap length, a measurement gap periodicity, a measurement gap pattern, a measurement gap offset, or a measurement gap identifier.

In some implementations, the processing device may send, to the source base station, information of a set of target handover parameters of the plurality of handover parameters, and receive, from the source base station, a notification that the set of target handover parameters has been matched with a set of source handover parameters of the plurality of handover parameters.

In some implementations, the processing device may send, to the source base station, information of a set of target handover parameters of the plurality of handover parameters, receive, from the source base station, a notification that a subset of the set of target handover parameters has not been matched with a set of source handover parameters of the plurality of handover parameters, and reconfigure the subset of the set of target handover parameters to match with the set of source handover parameters.

At operation 730, the processing device may determine whether a matched set of the plurality of handover parameters exists. In some implementations, to determine whether a matched set of the plurality of handover parameters exists, the processing device may determine whether a set of source handover parameters of the plurality of handover parameters matches with a set of target handover parameters of the plurality of handover parameters.

At operation 740, responsive to determining that the matched set exists, the processing device may send a notification regarding the matched set to the source base station. In some implementations, the processing device may receive, from the source base station, an acknowledgement to confirm the receipt of the notification regarding the matched set. In some implementations, responsive to determining that the matched set does not exist, the processing device may send, to a service provider, a request to have one or more handover parameters of the plurality of handover parameters be matched with corresponding handover parameters of the source base station.

At operation 750, the processing device may perform handover with user equipment (UE) using the matched set of the plurality of handover parameters.

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMS, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A method of efficient handover in inter vendor handover scenario in a cellular network, the method comprising:
sending, by a source base station, a handover request to a target base station;
exchanging a plurality of handover parameters with the target base station;
determining whether a matched set of the plurality of handover parameters exists;
responsive to determining that the matched set exists, sending a notification regarding the matched set to the target base station; and
performing handover with user equipment (UE) using the matched set of the plurality of handover parameters.

2. The method of claim 1, wherein the plurality of handover parameters comprises at least one of: a parameter associated with transmission of synchronization signals, a measurement gap related parameter, and an essential parameter for performing the handover.

3. The method of claim 2, wherein the parameter associated with transmission of synchronization signals comprises at least one of: a location of synchronization signal transmitted in a physical resource block, or an index of the physical resource block.

4. The method of claim 2, wherein the measurement gap related parameter comprises at least one of: a measurement gap length, a measurement gap periodicity, a measurement gap pattern, a measurement gap offset, or a measurement gap identifier.

5. The method of claim 1, wherein exchanging the plurality of handover parameters with the target base station comprises:
sending, to the target base station, information of a set of source handover parameters of the plurality of handover parameters; and
receiving, from the target base station, a notification that the set of source handover parameters has been matched with a set of target handover parameters of the plurality of handover parameters.

6. The method of claim 1, wherein exchanging the plurality of handover parameters with the target base station comprises:
sending, to the target base station, information of a set of source handover parameters of the plurality of handover parameters;
receiving, from the target base station, a notification that a subset of the set of source handover parameters has not been matched with a set of target handover parameters of the plurality of handover parameters; and
reconfiguring the subset of the set of source handover parameters to match with the set of target handover parameters.

7. The method of claim 1, wherein determining whether the matched set of the plurality of handover parameters exists comprises:
determining whether a set of source handover parameters of the plurality of handover parameters matches with a set of target handover parameters of the plurality of handover parameters.

8. The method of claim 1, further comprising:
responsive to determining that the matched set does not exist, sending, to a service provider, a request to have one or more handover parameters of the plurality of handover parameters be matched with corresponding handover parameters of the target base station.

9. A computing system to facilitate a cellular network, the computing system comprising:
one or more processing devices; and
memory communicatively coupled with and readable by the one or more processing devices and having stored therein processor-readable instructions which, when executed by the one or more processing devices, cause the one or more processing devices to perform operations comprising:
sending, by a source base station, a handover request to a target base station;
exchanging a plurality of handover parameters with the target base station;
determining whether a matched set of the plurality of handover parameters exists;
responsive to determining that the matched set exists, sending a notification regarding the matched set to the target base station; and
performing handover with user equipment (UE) using the matched set of the plurality of handover parameters.

10. The computing system of claim 9, wherein the plurality of handover parameters comprises at least one of: a parameter associated with transmission of synchronization signals, a measurement gap related parameter, and an essential parameter for performing the handover.

11. The computing system of claim 10, wherein the parameter associated with transmission of synchronization signals comprises at least one of: a location of synchronization signal transmitted in a physical resource block, or an index of the physical resource block.

12. The computing system of claim 10, wherein the measurement gap related parameter comprises at least one of: a measurement gap length, a measurement gap periodicity, a measurement gap pattern, a measurement gap offset, or a measurement gap identifier.

13. The computing system of claim 9, wherein exchanging the plurality of handover parameters with the target base station comprises:
sending, to the target base station, information of a set of source handover parameters of the plurality of handover parameters; and
receiving, from the target base station, a notification that the set of source handover parameters has been matched with a set of target handover parameters of the plurality of handover parameters.

14. The computing system of claim 9, wherein exchanging the plurality of handover parameters with the target base station comprises:
sending, to the target base station, information of a set of source handover parameters of the plurality of handover parameters;
receiving, from the target base station, a notification that a subset of the set of source handover parameters has not been matched with a set of target handover parameters of the plurality of handover parameters; and
reconfiguring the subset of the set of source handover parameters to match with the set of target handover parameters.

15. The computing system of claim 9, wherein determining whether the matched set of the plurality of handover parameters exists comprises:
determining whether a set of source handover parameters of the plurality of handover parameters matches with a set of target handover parameters of the plurality of handover parameters.

16. The computing system of claim 9, wherein the operations further comprises:
responsive to determining that the matched set does not exist, sending, to a service provider, a request to have one or more handover parameters of the plurality of handover parameters be matched with corresponding handover parameters of the target base station.

17. One or more non-transitory, computer-readable storage media having computer-readable instructions thereon which, when executed by one or more processing devices, cause the one or more processing devices to perform operations comprising:
sending, by a source base station, a handover request to a target base station;
exchanging a plurality of handover parameters with the target node;
determining whether a matched set of the plurality of handover parameters exists;
responsive to determining that the matched set exists, sending a notification regarding the matched set to the target base station; and
performing handover with user equipment (UE) using the matched set of the plurality of handover parameters.

18. The one or more non-transitory, computer-readable storage media of claim 17, wherein the plurality of handover parameters comprises at least one of: a parameter associated with transmission of synchronization signals, a measurement gap related parameter, and an essential parameter for performing the handover.

19. The one or more non-transitory, computer-readable storage media of claim 18, wherein the parameter associated with transmission of synchronization signals comprises at least one of: a location of synchronization signal transmitted in a physical resource block, or an index of the physical resource block.

20. The one or more non-transitory, computer-readable storage media of claim 18, wherein the measurement gap related parameter comprises at least one of: a measurement gap length, a measurement gap periodicity, a measurement gap pattern, a measurement gap offset, or a measurement gap identifier.
